(19) United States
(12) Patent Application Publication
(10) Pub. No.: US 2013/0105607 A1
(43) Pub. Date: May 2, 2013

(54) PULVERIZING APPARATUS

(71) Applicants: Masahiro Yoshikawa, Yawata-shi (JP); Takashi Shibata, Kyoto-shi (JP); Kohei Hosokawa, Toyonaka-shi (JP)

(72) Inventors: Masahiro Yoshikawa, Yawata-shi (JP); Takashi Shibata, Kyoto-shi (JP); Kohei Hosokawa, Toyonaka-shi (JP)

(73) Assignee: HOSOKAWA MICRON CORPORATION, Hirakata-shi, Osaka (JP)

(21) Appl. No.: 13/696,101

(22) PCT Filed: Apr. 28, 2011
(86) PCT No.: PCT/JP2011/060476

§ 371 Date: Jan. 18, 2013

(30) Foreign Application Priority Data
May 6, 2010 (JP) 2010-106684

(51) Int. Cl. B02C 13/288

(52) U.S. Cl. CPC B02C 13/288
USPC 241/57

(57) ABSTRACT

A pulverizing apparatus for processing a powder material that can be readily melted by friction heat generated between the pulverizing apparatus and the material. The pulverizing apparatus includes a casing (2) having a cylindrical inner face, a rotor (10) driven to rotate about the axis X of the casing and having a rugged portion (10G) in its outer periphery, a gas source providing a gas flow for conveying the powder material from a feed opening (3) provided at an end of the casing along the an axial direction to a discharge opening (4) provided at the other axial end of the casing, a coolant source providing coolant to flow in a coolant passage (15) formed inside the rotor. The rugged portion is divided along the axial direction by an annular cutout portion (11) extending along the peripheral direction of the rotor.

### TECHNICAL FIELD

The present invention relates to a pulverizing apparatus including a casing having a cylindrical inner face, a rotor driven to rotate about the axis of the casing and having an rugged portion in its outer periphery, a gas flow forming means for forming a gas flow for conveying the powder material from a feed opening provided at an end of the casing along the axis direction to a discharge opening provided at the other axial end of the casing, and a coolant supplying means for causing coolant to flow in a coolant passage formed inside the rotor.

### BACKGROUND ART

As a prior art document relating to the pulverizing apparatus of the above-noted type, there is Patent Document 1 identified below. With the pulverizing apparatus disclosed in this Patent Document 1, the outer peripheral portion of the rotor can be cooled effectively by means of a coolant which is circulated inside the rotor, in addition to a conventionally known cooling means from the casing side. Therefore, it is said that this can effectively restrict the phenomenon of a pulverization-object material that can be readily melted by friction heat, such as toner, raw material powder of powdered paint, being fused on and adhered to the surface of the rotor, which makes any further continuation of processing difficult or even impossible.

### PRIOR ART DOCUMENT

### Patent Document

Patent Document 1: Japanese Unexamined Patent Application Publication No. 2004-42029 (paragraph 0031, FIG. 1).

### SUMMARY OF THE INVENTION

### Object to be Achieved by Invention

However, when processing-object material is processing-object powder such as toner, powdered paint that can be readily melted by friction heat, the arrangement provided in e.g. the pulverizing apparatus disclosed in Patent Document 1, that relies, for the cooling of the outer peripheral portion of the rotor, only on coolant which is caused to circulate inside the rotor, it was not possible to obtain powder material having sufficiently fine particle size in a high yield.

Then, in view of the above-described state of the art, the object of the present invention is to obtain a pulverizing apparatus capable of obtaining a product with sufficiently fine particle size in a higher yield, even when the apparatus is to process a pulverization-object material that can be readily melted by friction heat generated between the material and the pulverizing apparatus.

### Means for Achieving the Object

According to a first characterizing feature of the present invention, a pulverizing apparatus comprises:

a casing having a cylindrical inner face;

a rotor driven to rotate about the axis of the casing and having an rugged portion in its outer periphery;

a gas flow forming means for forming a gas flow for conveying the powder material from a feed opening provided at an end of the casing along the axis direction to a discharge opening provided at the other axial end of the casing; and

a coolant supplying means for causing coolant to flow in a coolant passage formed inside the rotor;

wherein the rugged portion is divided along the axis direction by an annular cutout portion extended along the peripheral direction of the rotor.

With the pulverizing apparatus according to the first characterizing feature of the present invention, there is provided an annular cutout portion that divides the rugged portion along the axis direction. This increases the area of contact between the rotor and the gas flowing inside the casing and the processing-object material being processed, so that the processing-object material, the gas flow and the vicinity of the surface of the rotor including the rugged portion are effectively cooled by the coolant flowing inside the rotor. As a result, when processing is effected on a pulverization-object material that can be readily melted by friction heat, such as toner, raw material powder of powdered paint, it becomes possible to pulverize the material with effectively restricting melting thereof, so that power material having sufficiently fine particle size can be obtained in a higher yield.

According to a further characterizing feature of the present invention, at a portion of the casing facing the cutout portion, there is provided an opening for introducing gas into the cutout portion of the rotor.

With this arrangement, as a cooling gas such as air, nitrogen, argon, helium, etc. is blown into the cutout portion of the rotor, the processing-object material present in the vicinity of the cutout portion can be positively cooled. Further, as the gas and the processing-object powder material are stirred together inside the cutout portion, the processing-object material inside the cutout portion is effectively cooled by the coolant inside the rotor via the end face of the rotor located at the cutout portion.

Further, in general, with the pulverizing process which proceeds with movement of the processing-object material toward the discharge opening, the temperature of the vicinity of the surface of the rotor including the rugged portion and the inner face of the casing becomes higher at positions closer to the discharge opening along the axial direction. With the above-described arrangement, however, since the cooling gas can be additionally introduced at an intermediate position along the axial direction, the temperature adjacent the discharge opening can be lowered.

Furthermore, with the above-described arrangement, through appropriate varying of the ratio of the gas to be introduced, among a plurality of gas introducing openings including the feed opening and the opening, the temperature distribution along the axial direction can be optimized, in accordance with the characteristics of the processing-object powder material to be processed, the size of the pulverizing apparatus, the working environment, etc.

According to a still further characterizing feature of the present invention, a plurality of sets of said annular cutout portions and said openings are provided along the axial direction.

With the above-described arrangement, as the cooling gas such as air, nitrogen, argon, helium, etc. is blown into the plurality of sets of cutout portions, even higher cooling effect can be provided to the processing-object material being processed. Further, with appropriate varying of the number and/or positions of the cutout portions into which the cooling gas is blown, free adjustment of the cooling level according to the object, the temperature condition of the surrounding, etc. too becomes possible.

According to a still further characterizing feature of the present invention, the cutout portion has a width that exceeds the opening width of said opening.

With the above arrangement, the gas introduced through the opening of the casing can easily advance deep inside the cutout portion. Hence, the cooling effect of the cutout portion to the processing-object material can be secured even more sufficiently.

According to a still further characterizing feature of the present invention, said coolant passage includes a peripheral annular passage adjacent said cutout portion along the axial direction; and said cutout portion has a radial depth substantially equal to the inner radial end of the annular passage.

The above-described arrangement further increases the area of contact between the rotor and the gas flowing inside the casing and the processing-object material being processed, so that the processing-object material, the gas flow and the vicinity of the surface of the rotor including the rugged portion are even more effectively cooled by the coolant flowing inside the rotor.

According to a still further characterizing feature of the present invention, a second coolant passage is formed inside the casing.

With the above-described arrangement, in addition to the cooling of the surface of the rotor including the rugged portion by the coolant inside the rotor, the inner face of the casing too is cooled by the coolant that is caused to flow inside the coolant passage inside the casing. Therefore, the tendency of melting of the processing-object material with the friction heat can be restricted even more effectively, so that the powder having even finer particle size can be obtained in an even higher yield.

### BRIEF DESCRIPTION OF THE DRAWINGS

FIG. 1 is a partially cutaway perspective view showing a pulverizing apparatus according to the present invention,

FIG. 2 is a cutaway side view showing the configuration of the pulverizing apparatus according to the present invention,

FIG. 3 is a perspective view showing a unit of a liner and a casing,

FIG. 4 is a perspective view showing a further embodiment of the unit of a liner and a casing,

FIG. 5 is an explanatory view illustrating the shapes of rugged portions of the rotor and the liner,

FIG. 6 is a graph illustrating the pulverizing effect with using the pulverizing apparatus according to the present invention,

FIG. 7 is a partially cutaway perspective view showing a pulverizing apparatus according to a further embodiment of the present invention,

FIG. 8 is a cutaway side view showing the configuration of the pulverizing apparatus according to the further embodiment of the present invention, and

FIG. 9 is a graph illustrating the pulverizing effect with using the pulverizing apparatus according to the further embodiment of the present invention,

### MODES OF EMBODYING THE INVENTION

Next, modes of embodying the present invention will be explained with reference to the accompanying drawings.

### First Embodiment

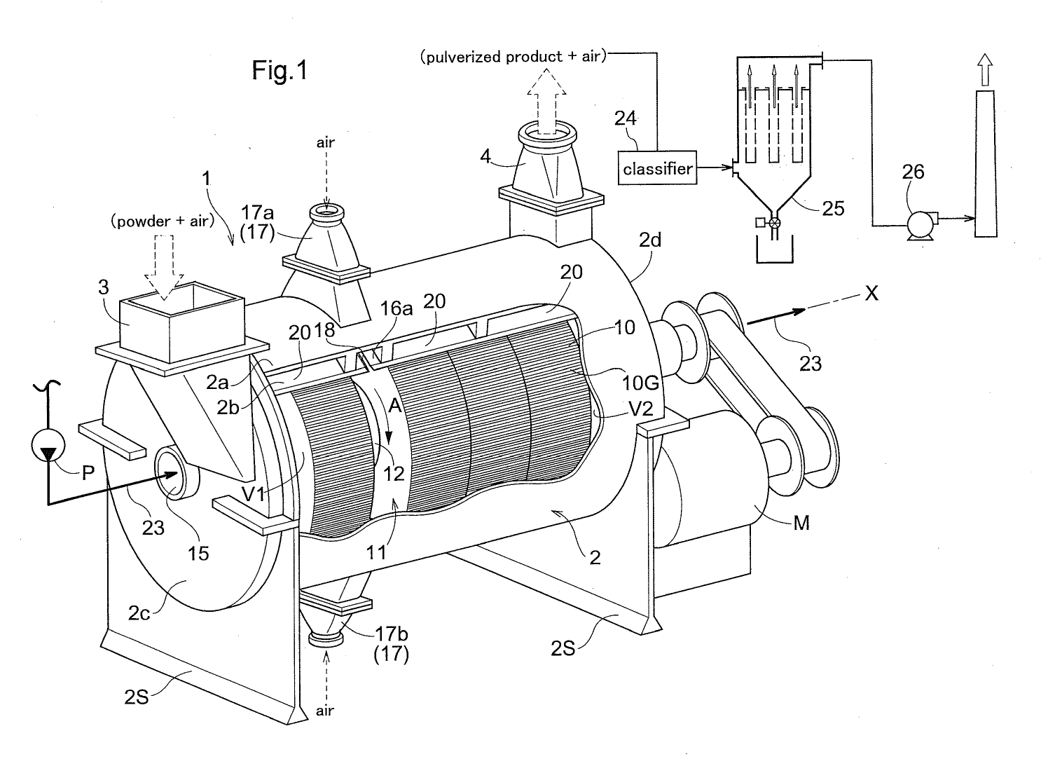

A pulverizing apparatus 1 shown in FIG. 1 is a device for pulverizing particles having an average particle diameter of a few tens of μm to a few mm's to fine powder of a few μm. The device is configured to process, as a processing-object material, a material containing as a main component thereof, a resin that can be readily melted with friction heat, such as toner, powdered paint, etc. in particular.

(General Construction of Pulverizing Apparatus)

The pulverizing apparatus 1 has a casing 2 having an inner face having a generally cylindrical inner face. The casing 2 includes an outer cylinder 2a supported by a plurality of leg portions 2S, a liner 2b disposed coaxially inside the outer cylinder 2a, and a pair of side wall portions 2c, 2d which close the space delimited by the liner 2b from the opposed ends thereof. Between the outer cylinder 2a and the liner 2b, there is formed a space for causing coolant or air to be described later to flow.

Inside the liner 2b, one rotor 10 is rotatably supported. In the inner face of the liner 2b and the outer peripheral face of the rotor 10, there are formed rugged portions for pulverizing the processing-object powder. The rotor 10 is driven to rotate at a high speed in the direction of arrow A by means of a motor M.

At one end of the casing 2 along the axis X direction, there is provided a feed opening 3 for receiving particles as a “raw material” together with air; and at the other end thereof, there is provided a discharge opening 4 for discharging pulverized powder together with the air. The feed opening 3 is provided at a position offset laterally from the axis X as seen in the plane view. The discharge opening 4 is provided at a position offset laterally to the side opposite the feed opening 3 along the axis X direction. In particular, the feed opening 3 and the discharge opening 4 are provided with an offset toward the tangent relative to the outer peripheral face of the rotor 10.

To the discharge opening 4, a blower 26 (an example of a “gas flow forming means”) is connected. And, between the blower 26 and the discharge opening 4, there is interposed a classifier 24 for collecting the pulverized particles for the respective particle size ranges. And, between the classifier 24 and the blower 26, there is interposed a bag filter 25 for collecting the finely pulverized particles.

The gas flow generated by the blower 26 is caused to flow from the feed opening 3 via the gap between the inner peripheral face of the liner 2b and the outer peripheral face of the rotor 10 and discharged from the discharge opening 4. In this course, as being passed through the bag filter 25, the processing-object material is conveyed inside the casing 2 from the feed opening 3 to the discharge opening 4 and the material is caused to eventually reach the bag filter 25. Incidentally, the classifier 24 will be used depending on the necessity. The entire amount of power may be collected directly by the bag filter 25, without using the classifier 24.

Further, the powder collected by the classifier 24 can be returned to the pulverizing apparatus 1 for re-pulverization thereof, and the material collected by the bag filter 25 can be used as the final product. Further alternatively, the powder collected by the bag filter 25 can be sent to another classifier for removal of fine particles, and the resultant material can be obtained as the final product.

[Configuration of Rotor]

The rotor 10 includes a shaft 10S rotatably driven by a motor M and a plurality of annular rotor pieces mounted on the shaft 10S. As the rotor pieces, there are provided two kinds, i.e. a first rotor piece 10PA having opposed end faces intersecting the axis X formed of simple flat face and a second rotor piece 10PB having one face intersecting the axis X and a small-diameter cylindrical portion 12 projecting from the one face toward the motor M.

In the instant embodiment, the rotor 10 consists of three first rotor pieces 10PA and one second rotor piece 10PB. The three first rotor pieces 10PA are disposed in gapless juxtaposition along the axis X at positions offset toward the motor M substantially. The second rotor piece 10PB is disposed in such a manner that there is formed substantially no gap between the motor M side end face of the small-diameter cylindrical portion 12 and the first rotor piece 10PA adjacent thereto.

Therefore, between a rugged portion 10G formed by the three first rotor pieces 10PA and a rugged portion 10G formed by the second rotor piece 10PG, there is formed one annular cutout portion 11. This cutout portion 11 is formed on the outer peripheral side of the small-diameter cylindrical portion 12 and extends along the entire periphery along the peripheral direction of the rotor 10.

Inside the rotor 10, there is formed a coolant passage 15 in a sealed state. The coolant passage 15 extends from a first end portion 10a of the shaft 10S supported by a first bearing 9a through the annular coolant passage 15 formed in the portion of the second rotor piece 10PB excluding the small-diameter cylindrical portion 12 and inside the three first rotor pieces 10PA to a second end portion 10b of the shaft 10S supported by a second bearing 9b.

The coolant passage 15 forms a peripherally extending annular passage 15R inside the individual rotor pieces 10PA, 10PB and the annular passages 15R of the mutually adjacent rotor pieces 10PA, 10PB are connected by a single coolant passage 15 extending parallel with the axis X at a position slightly radially outer side of the shaft 10S.

A pump P (an example of a “coolant supplying means”) is provided for feeding coolant such as cold water from the first end portion 10a to the coolant passage 15 so as to cool warmed coolant discharged from the second end portion 10b with a heat exchanger 14 and feeding this coolant again toward the first end portion 10a. The radial depth of the cutout portion 11 is set to be substantially equal to the inner diameter side end portion of the annular passage 15R.

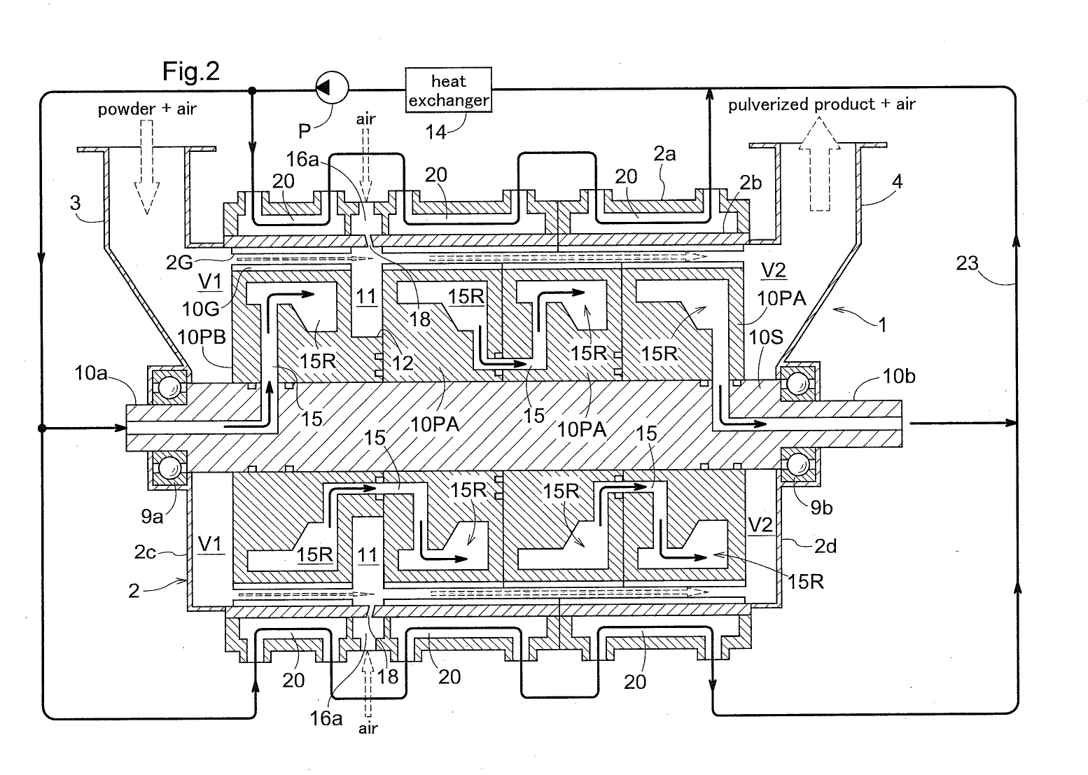

As shown in FIG. 2, a rugged portion 2G on the side of the liner 2b is provided only at the area of the rotor 10 where its rugged portion 10G is located. And, between the position of the liner 2b closest to the feed opening 3 and the position of the liner 2b closest to the discharge opening 4, there are provided annular buffer spaces V1, V2 where neither the rotor pieces 10PA, 10PB nor the rugged portion 2G of the liner 2b are existent.

Further, the shaft 10S of the rotor 10 is rotatably supported via the pair of bearings 9a, 9b mounted at the centers of the side wall portions 2c, 2d.

(Configuration of Middle-Stage Gas Introducing Means)

The pulverizing apparatus 1 includes a middle-stage gas introducing means for introducing air to the inside of the liner 2b at an intermediate position (middle stage) along the axis X, separately of the feed opening 3. The middle-stage gas introducing means includes one annular gas passage 16a formed by partitioning the space between the outer cylinder 2a and the liner 2b at a position corresponding to the cutout portion 11 along the axis X and two gas supplying cases 17 provided upwardly and downwardly of the outer cylinder 2a to communicate to this annular gas passage 16a. The gas passage 16a is communicated to the interior of the liner 2d via an annular slit 18 (an example of an “opening”) formed by cutting out a portion of the liner 2b in a peripheral form.

As seen in a section view of the liner 2b along a plane including the axis X, the width of the annular slit 18 is sufficiently smaller than the width of the cutout portion 11 and the annular slit 18 extends with an inclination radially relative to the axis X. The centerline of the annular slit 18 having such inclination as above is directed toward the end face of the first rotor piece 10PA constituting the cutout portion 11 which this annular slit 18 faces. The inclination angle of the annular slit 18 can be set from 15 to 20 degrees, for example. The upper and lower gas supplying cases 17a, 17b disposed toward the feed opening 3 are communicated to the single common gas passage 16a.

With the function of the blower 26 described hereinbefore, air is introduced to the inside of the liner 2b also through the annular slits 18 via the two gas supplying cases 17 (17a, 17b). The amount of air discharged from the discharge opening 4 is in agreement with the total amount of air introduced to the inside of the liner 2b via the annular slits 18 from the feed opening 3 and the two gas supplying cases 17.

At each outer end of the two gas supplying cases 17, there is provided an adjusting valve (not shown) capable of adjusting the area of the opening communicated to the ambient air. Through adjustment of the apertures of these adjusting valves, it is possible to vary the amount of air to be introduced through each gas supplying case 17. And, it is also possible to vary the ratio between the amount of air to be introduced from the feed opening 3 and the total amount of air to be introduced from the two gas supplying cases 17. However, in the case of a standard method of operation, about ½ of the total amount of air introduced into the liner 2b is introduced from the feed opening 3 and about ½ of the total amount is introduced from the gas supplying cases 17a, 17b.

(Configuration of Liner)

Of the space between the outer cylinder 2a and the liner 2b, a portion thereof excluding the single annular gas passage 16a forms a second coolant passage 20 for cooling the liner 2b with coolant such as cold water. While the gas passage 16a presents a form of single ring, the coolant passage 20 is divided into two or four areas juxtaposed along the peripheral direction by means of partition walls (not shown) extending horizontally. In this coolant passage 20, the coolant is caused to circulate through a coolant circuit 23 including the pump P and the heat exchanger 14 that are shared with the coolant passage 15.

In this embodiment, for both the coolant passage 15 inside the rotor 10 and the coolant passage 20 inside the casing 2, the orientation of the pump P and the layout of the coolant circuit 23 are set such that the coolant may be caused to flow from the feed opening 3 toward the discharge opening 4. However, in accordance with the characteristics of the processing-object powder and/or method of using the auxiliary gas introducing means, these may be set such that the coolant is caused to flow in the reverse direction.

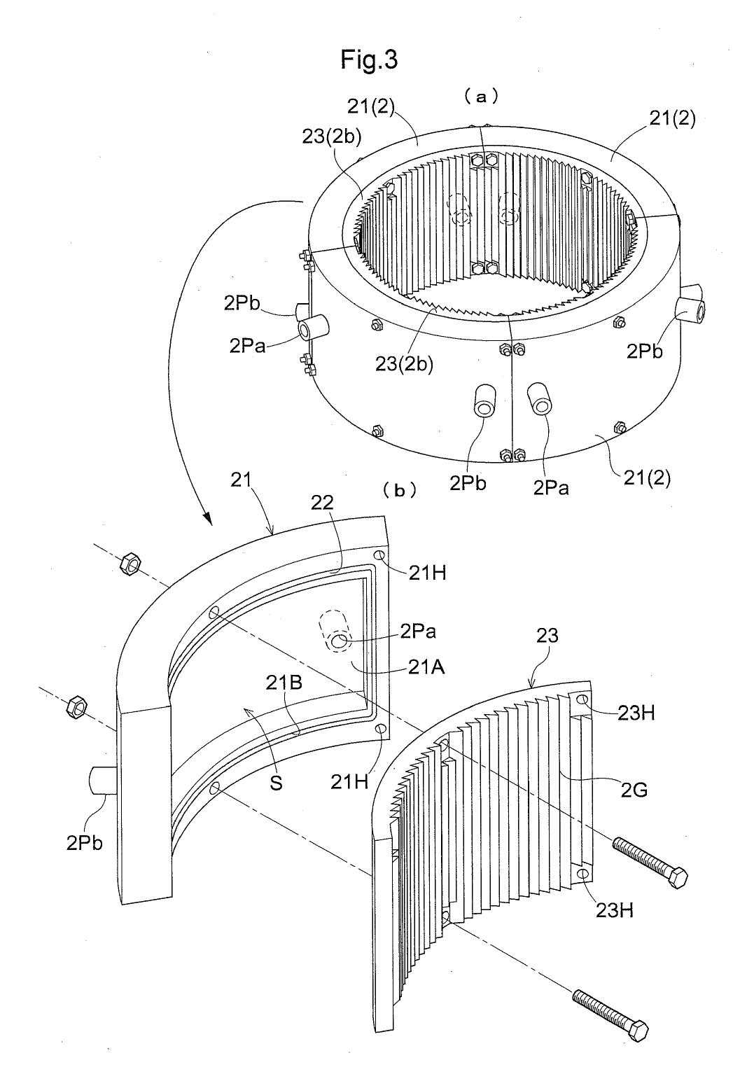

The casing 2 and the liner 2b may be divided into a plurality of blocks juxtaposed along the axis X. And, one block of them may be divided into a plurality of small blocks along the peripheral direction also, as illustrated in FIG. 3.

In the case of the example illustrated in FIG. 3, each individual small block is constituted of a case-like casing piece 21 and a liner piece 23 which closes an opening portion 21A provided on the radially inner side of the casing piece 21.

The opening portion 21A of the casing piece 21 presents a curved rectangular shape; and into a seal groove 21B formed in the radially inwardly oriented end face of the edge portion constituting the opening portion 21A, an annular elastic seal 22 is fitted.

The liner piece 23 is fixed to the casing piece 21 with bolts, nuts, etc. via through holes 23H formed at six portions of the liner piece 23 including four corner portions thereof and through holes 21H formed in the casing piece 21. In this fixing, as the bolts and the nuts are progressively tightened to each other, the elastic seal 22 is pressed against the smooth outer peripheral face of the liner piece 22, thus sealing the inner space of the casing piece 21.

Each casing piece 21 includes an input port 2Pa and an output port 2Pb constituting the second coolant passage 20, with the input port 2Pa and the outer port 2P being spaced apart from each other along the peripheral direction. And, in the inner peripheral face of the liner piece 23, a rugged portion 2G is formed integral therewith. Incidentally, in the illustration of FIG. 1, the input portion 2Pa and the output port 2Pb are omitted therefrom.

As the second coolant passage 20 is constituted of the space S surrounded by the casing piece 21 and the liner piece 23, through the coolant coming into direct contact with the outer peripheral face of the liner piece 23, a high cooling effect can be obtained also for the vicinity of the rugged portion 2G of the liner 2b.

[Modified Embodiment of Liner]

In the space S surrounded by the casing piece 21 and the liner piece 23, as a means for preventing the phenomenon of the coolant taking a shortcut route with the shortest possible distance from the input port 2Pa to the output port 2Pb, a plurality of fin-like blocking plates 21S may be provided in the inner peripheral face of the casing piece 21.

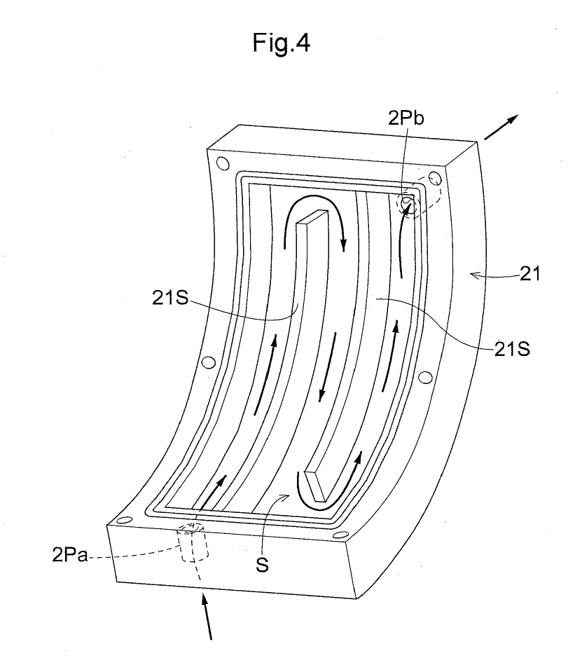

In the case of the embodiment shown in FIG. 4, two blocking plates 21S shorter than the inner peripheral size of the inner peripheral face of the casing piece 21 extend along the peripheral direction and are spaced apart from each other along the axial direction. Further, these plates are arranged such that one blocking plate 21S opens the passage only on one side in the peripheral direction, and the other blocking plate 21S opens the passage only on the other side in the peripheral direction.

In this way, the input port 2Pa and the output port 2Pb are disposed respectively at one end and the other end of the passage which is provided with an increased length due to the presence of the blocking plates 21S. With the above-described arrangement in operation, the coolant which has entered the space S from the input port 2Pa is caused to flow thoroughly within the entire space S and discharged from the output port 2Pb, whereby the entire surface of the liner 23 may be readily cooled in a uniform manner.

[Configuration of Rugged Portion]

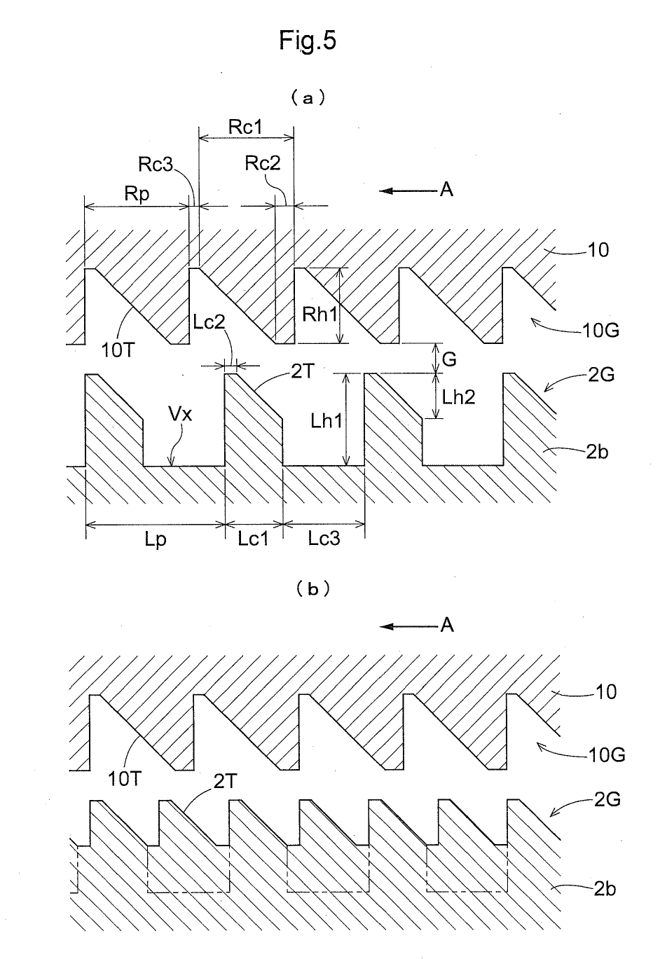

FIG. 5 (a) illustrates the sectional shapes of the rugged portions 2G, 10G in the first embodiment. As may be understood from FIG. 5 (a), pulverizing teeth 2T (convex portions) of the rugged portion 2G on the side of the liner 2b and pulverizing teeth 10T (convex portions) of the rugged portion 10G on the side of the rotor 10 each have right/left asymmetrical shape, so that basically the side thereof having gentler inclination is on the forward side in the direction of relative movements, relative to the rotational direction (the arrow A) of the rotor 10.

In the configuration of the rugged portion 2G on the side of the liner 2b illustrated in FIG. 5 (a), for the purpose of e.g. increasing the cooling efficiency, as compared with FIG. 5 (b) showing the pattern of the conventional rugged portion 2G, the number of pulverizing teeth 2T is reduced to half, so that the volume of the space between the opposed rugged portions 2G, 10G is effectively increased, without changing the gap distance G between the two rugged portions 2G, 10G.

More particularly, if serial numbers are provided to the individual pulverizing teeth 2T shown in FIG. 5 (b) along the peripheral direction, in the rugged portion 2G shown in FIG. 5 (a), either all the pulverizing teeth 2T provided with the even serial numbers or odd serial numbers are eliminated and moreover the flat face portion (the portion defined by the base end of the remaining pulverizing tooth 2T and the base end of the pulverizing tooth 2T adjacent thereto) formed by the elimination of the pulverizing teeth 2T is dug down to a depth substantially equal to the height of the pulverizing tooth 2T, thus forming a recess Vx having a rectangular cross section.

The configuration of the unique rugged portion 2G described above can be expressed as a rugged portion 2G wherein a half of each every two pulverizing teeth 2T continuously juxtaposed along the peripheral direction relative to the rotational axis of the rotor are eliminated and a recess having a substantially equal depth as the height of the pulverizing teeth 2T prior to the elimination is formed between the remaining pulverizing teeth 2T adjacent to each other.

Incidentally, for the purpose of adjustment of the increasing amount of the space volume, the depth of the recess formed between adjacent remaining pulverizing teeth 2T can vary appropriately. Or, the invention can also be embodied without such recess at all. Moreover, the cross sectional shape of the recess can be a curved shape having substantially no corner portions, such as an inwardly opened arc form, rather than the rectangular shape shown in FIG. 5.

Further, the above-described configuration of the characterizing rugged portion 2G can be applied to the rugged portion 10G on the side of the rotor 10, rather than the rugged portion 2G on the side of the liner 2b.

One preferred example of the specific numerical values of the respective parts of the rugged portion 2G on the side of the liner 2b illustrated in FIG. 5 (a) are: Lc1: 2.0 mm, Lc2: 0.45 mm, Lh1: 3.0 mm, Lh2: 1.5 mm, Lc: 3:2.6 mm, Lp: 4.6 mm.

On the other hand, one preferred example of the specific numerical values of the respective parts of the rugged portion 10G on the side of the rotor 10 illustrated in FIG. 5 (a) are: Rc1: 3.1 mm, Rc2: 0.6 mm, Rc3: 0.3 mm, Rh1: 2.5 mm, Rp: 3.4 mm.

The pitch of the pulverizing teeth 2T on the side of the liner 2b and the pitch of the pulverizing teeth 10T on the side of the rotor 10 when the above-described numeric values are applied have a ratio of 4:3.

The above-described numeric values are only some preferred example. Hence, these may vary appropriately in accordance with the physical properties of the pulverization-object material, the target pulverized particle diameter, etc.

The gap G in the radial direction between the convex portions of the rugged portion 2G on the inner face of the liner 2b and the convex portions of the rugged portion 10G on the outer peripheral face of the rotor 10 can be designed to decrease progressively from the feed opening 3 side toward the discharge opening 4 side. In this case, the average value of this gap G along the entire length in the axis X direction can be set to e.g. about 1 mm, but this can vary in many ways, in accordance with e.g. the properties of the pulverization-object powder.

Further, in addition to the gap G in the radial direction between the convex portions of the rugged portion 2G on the inner face of the liner 2b and the convex portions 10G on the outer peripheral face of the rotor 10, it is also possible to vary, for each rotor piece 10PA, 10PB, the number of the rugged portions, the shape, the depth of the recess, etc.

Further, the manner of combining the first rotor piece 10PA and the second rotor piece 10PB is not limited to the example described above. Instead, for instance, the first rotor pieces 10PA on the side of the motor M may be reduced to two, whereas the second rotor pieces 10bPB on the side opposite the motor M may be increased to two, thereby to provide a plurality of sets of annular cutout portions 11 and annular slits 18 along the axis X direction. In this case, by feeding cooling gas such as air, nitrogen, argon, helium, etc. into the plurality of sets of cutout portions 11, even higher cooling effect can be provided to the processing-object powder during its pulverizing operation.

### Example Using First Embodiment

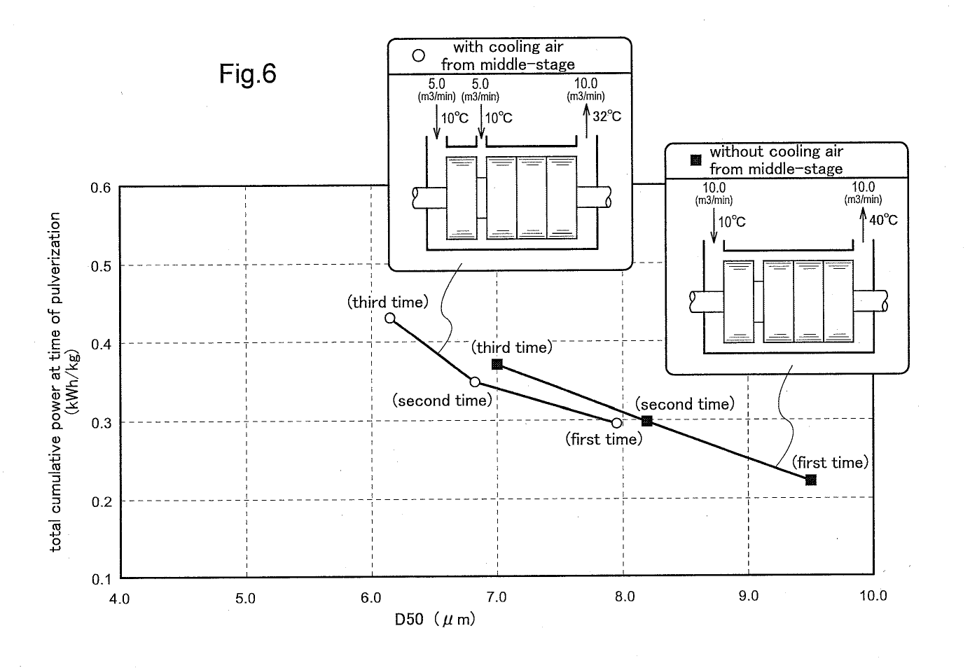

FIG. 6 shows the result of pulverization effected with using the pulverizing apparatus shown in FIGS. 1-3 and FIG. 5 (a).

In this, the same pulverizing apparatus was employed and comparison was made between two pulverizing methods, i.e. pulverization according to the present invention with using the middle-stage gas introducing means and pulverization according to the present invention without using the middle-stage gas introducing means. Incidentally, in this example, for comparison of pulverizing efficiency of the two pulverizing methods, the classifier 24 was not employed, and substantially entire amount of the powder discharged from the discharge opening 4 was collected by the bag filter 25.

In the graph shown in FIG. 6, the horizontal axis represents the average particle size (μm) of the pulverized product obtained by each pulverization and the vertical axis represents the total cumulative power per 1 kg of pulverized product (kWh/kg) consumed by the motor M at the time of each pulverization.

Incidentally, the particle diameter of the pulverized product was determined with using a Coulter counter (manufactured by Beckman Coulter, Inc.) and the median diameter (D50) was used as the average particle diameter.

As shown in the schematic graph of FIG. 6, in the case of the pulverization using the middle-stage gas introducing means (denoted with ◯), the pulverization was carried out with air introduction of a same flow rate (5.0 m³/min) throughout from the two positions of the feed opening 3 and the gas passage 16a. On the other hand, in the case of the pulverization not using the middle-stage gas introducing means (denoted with ▪), the air introduction of 10.0 m³/min was effected only from one position of the feed opening 3.

In both pulverization methods above, for the air introduction, at having an approximately room temperature of about 10° C. was introduced.

Also, in both of the two pulverization methods above, the cooling of the rotor 10 and the casing 2 using the coolant passage 15, the coolant passage 20 and the coolant circuit 23 was effected under the same conditions.

In both pulverization methods above, the rotational speed at the vicinity of the rugged portion 10G of the rotor 10 was 150 m/sec, and the power used for the rotation of the rotor 10 was 30 kW at its maximum.

In both pulverization methods above, total of three times of continuous pulverization were effected in the manner described below.

(1) An amount of cyan toner having the maximum particle size of 4 mm (an example of “processing-object powder”) was fed from the feed opening 3 at the feed rate of about 120 kg/h, and the pulverized product discharged from the discharge opening 4 in its entire amount was collected as first pulverized product and the average particle size (first time) was determined and recorded.

(2) The first pulverized product in its entire amount was fed from the feed opening 3 at the feed rate of about 120 kg/h and pulverized product discharged from the discharge opening 4 was collected in its entire amount as second pulverized product and the average particle size (second time) was determined and recorded.

(3) The second pulverized product in its entire amount was fed from the feed opening 3 at the feed rate of about 120 kg/h and pulverized product discharged from the discharge opening 4 was collected in its entire amount as third pulverized product and the average particle size (third time) was determined and recorded.

As shown in FIG. 6, in the case of the pulverization using the middle-stage gas introducing means, the average particle size of the pulverized product obtained after the first time of pulverization was about 8.0 μm and the size was about 6.8 μm after the second time and the size reached about 6.1 μm after the third time.

On the other hand, in the case of the pulverization not using the middle-stage gas introducing means, the average particle size of the pulverized product obtained after the first time of pulverization was about 9.5 μm and the size was about 8.2 μm after the second time and the size was about 7.0 μm after the third time.

As described above, significant effects of the pulverization using the middle-stage gas introducing means were confirmed, such as the ability of obtaining pulverized product of average particle size of about 7 μm after the second pass, in contrast to the pulverization without using the middle-stage gas introducing means which required three times of pass until the pulverized product having the average particle size of about 7 μm could be obtained.

Incidentally, as shown in the schematic graph of FIG. 6, in the case of the pulverization not using the middle-stage gas introducing means, the temperature of the gas at the discharge opening 4 was 40° C., whereas in the case of the pulverization using the middle-stage gas introducing means, the temperature of the same gas was 32° C. This result also shows the cooling effect by the middle-stage gas introducing means.

### Second Embodiment

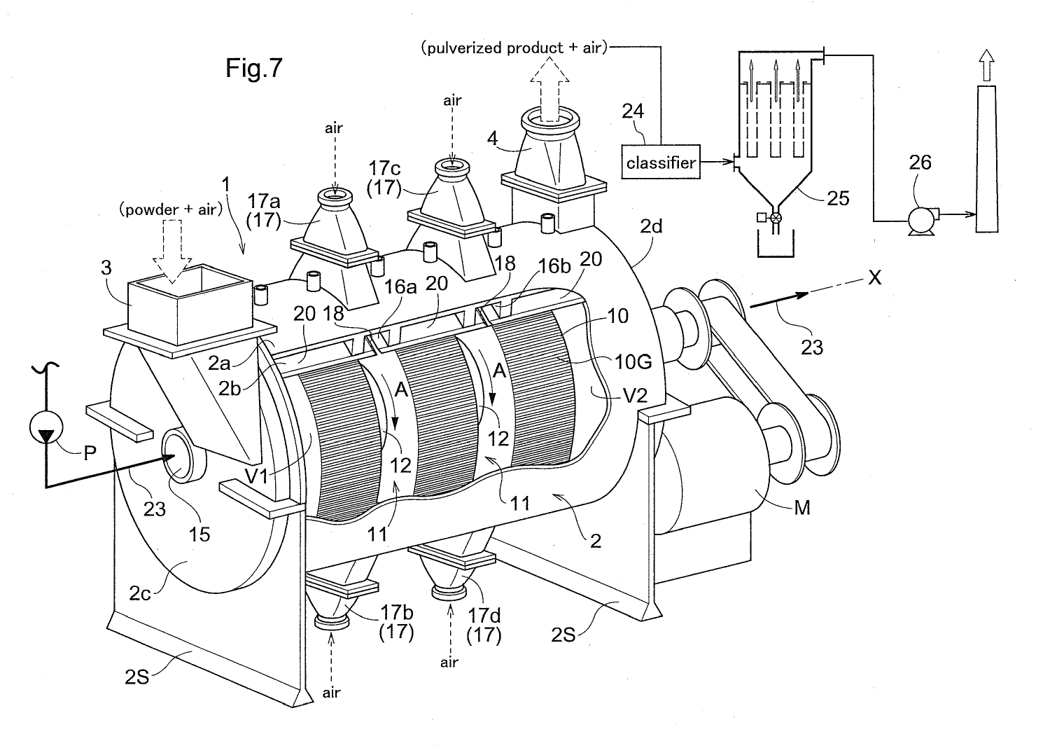

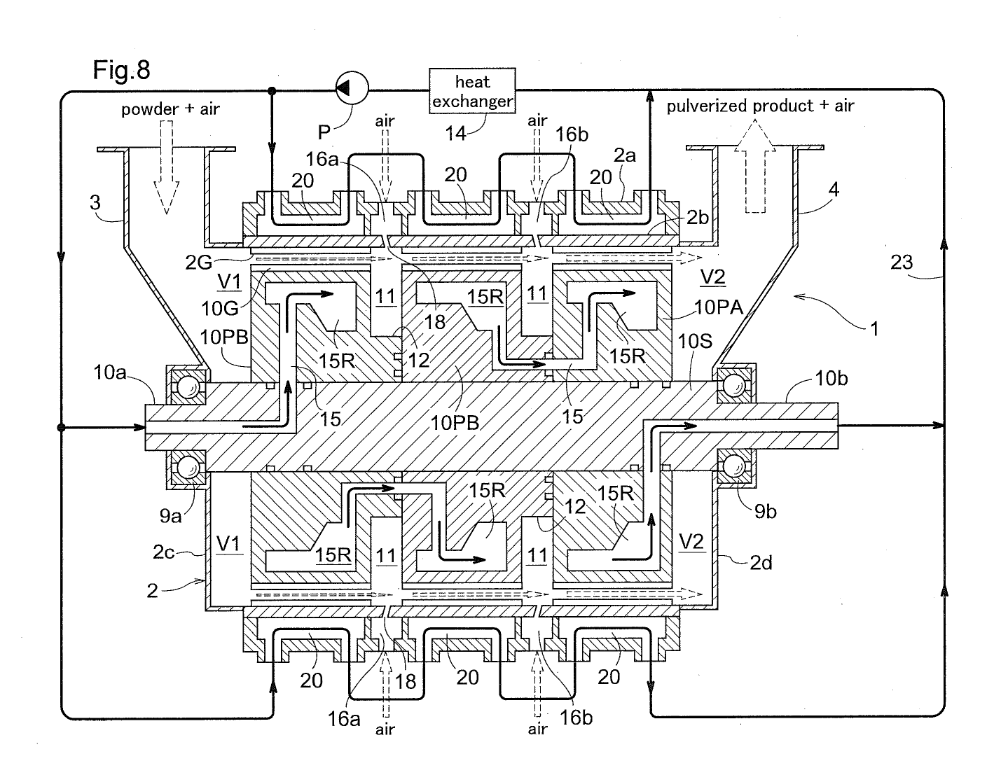

A pulverizing apparatus of the invention shown in FIGS. 7 and 8 is identical in its basic configuration to the first embodiment described above.

Referring to the difference between the first embodiment and the second embodiment, in this second embodiment, the rotor 10 consists of one first rotor piece 10PA and two second rotor pieces 10PB. The one first rotor piece 10PA is disposed at a position closest to the motor M. Of both the two second rotor pieces 10PB, the small-diameter cylindrical portion 12 is disposed with an orientation toward the motor M side.

Therefore, between the rugged portion 10G formed by the one first rotor piece 10PA and the rugged portion 10G formed by the two second rotor pieces 10PB, there are formed two annular cutout portions 11 spaced apart from each other along the axis X.

The middle-stage gas introducing means in the second embodiment includes two annular gas passages 16a, 16b formed by partitioning the space between the outer cylinder 2a and the liner 2b in the form of a cylinder at positions corresponding to the two cutout portions 11 along the axis X and four gas supplying cases 17 provided upwardly and downwardly of the outer cylinder 2a so as to communicate to this gas passage 16a. The gas passage 16a is communicated to the interior of the liner 2b via two annular slots (an example of an “opening”) formed by cutting out a portion of the liner 2a in the peripheral form.

The upper and lower two gas supplying cases 17a, 17b located with an offset toward the feed opening 3 are communicated to the single common gas passage 16a and at the same time the upper and lower two gas supplying cases 17c, 17d located with an offset toward the discharge opening 4 are communicated to the other gas passage 16b.

With the function of the blower 26 described hereinbefore, air is introduced to the inside of the liner 2b also through the annular slits 18 via the four gas supplying cases 17 (17a, 17b, 17c, 17d). The amount of air discharged from the discharge opening 4 is in agreement with the total amount of air introduced to the inside of the liner 2b via the feed opening 3 and the four gas supplying cases 17. At each outer end of the four gas supplying cases 17, there is provided an adjusting valve (not shown) capable of adjusting the area of the opening communicated to the ambient air. Through adjustment of the apertures of these adjusting valves, it is possible to vary the amount of air to be introduced from each gas supplying case 17. And, it is also possible to vary the ratio between the amount of air to be introduced from the feed opening 3 and the total amount of air to be introduced from the four gas supplying cases 17.

However, in the case of a standard method of operation, about ⅓ of the total amount of air introduced into the liner 2b is introduced from the feed opening 3, about ⅓ of the total amount is introduced from the gas supplying cases 17a, 17b closer to the feed opening 3 and about ⅓ of the total amount is introduced from the gas supplying cases 17c, 17d closer to the discharge opening 4.

In this second embodiment too, for both the coolant passage 15 inside the rotor 10 and the coolant passage 20 inside the casing 2, the orientation of the pump P and the layout of the coolant circuit 23 are set such that the coolant may be caused to flow from the feed opening 3 toward the discharge opening 4. However, in accordance with the characteristics of the processing-object powder and/or method of using the auxiliary gas introducing means, these may be set such that the coolant is caused to flow in the reverse direction.

In the second embodiment, the shapes shown in FIG. 5 (b) are applied to the rugged portion 2G on the side of the liner 2b and the rugged portion 10G on the side of the rotor 10, and the ratio between the pitch of the pulverizing teeth 2T on the side of the liner 2b and the pitch of the pulverizing teeth 10T on the side of the rotor 10 is set to 4:6.

Needless to say, the inclination angles, the shapes and sizes of the pulverizing teeth can vary, in accordance with the properties of the processing-object powder, etc.

### Example Using Second Embodiment

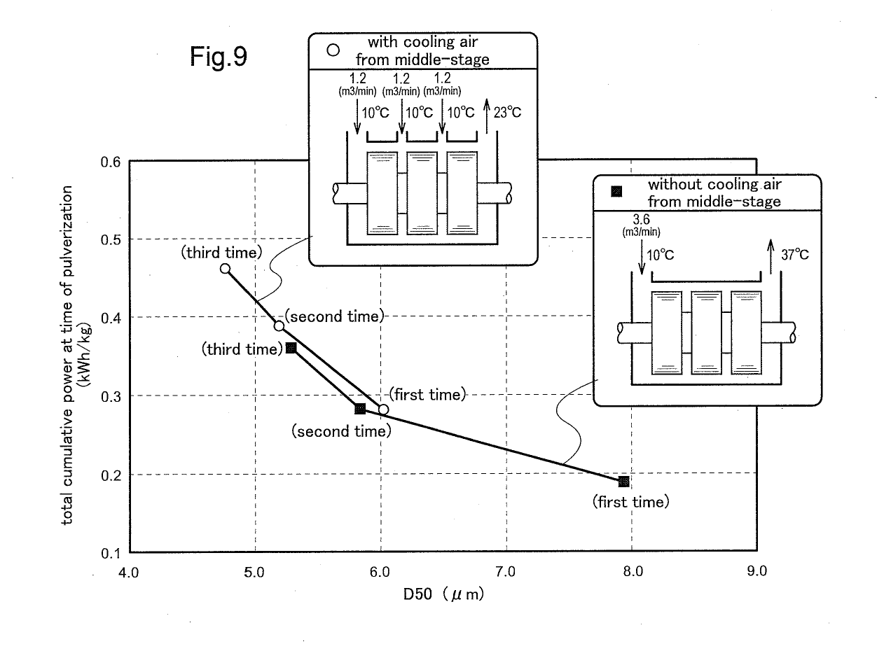

FIG. 9 shows the result of pulverization effected with using the pulverizing apparatus shown in FIG. 7, FIG. 8 and FIG. 5 (b).

In this example too, the same pulverizing apparatus was employed and comparison was made between two pulverizing methods, i.e. pulverization according to the present invention with using the middle-stage gas introducing means and pulverization according to the present invention without using the middle-stage gas introducing means. Incidentally, in this example, for comparison of pulverizing efficiency of the two pulverizing methods, the classifier 24 was not employed, and substantially entire amount of the powder discharged from the discharge opening 4 was collected by the bag filter 25.

In the graph shown in FIG. 9, the horizontal axis represents the average particle size (μm) of the pulverized product obtained by each pulverization and the vertical axis represents the total cumulative power per 1 kg of pulverized product (kWh/kg) consumed by the motor M at the time of each pulverization.

Incidentally, the particle diameter of the pulverized product was determined with using the Coulter counter (manufactured by Beckman Coulter, Inc.) and the median diameter (D50) was used as the average particle diameter.

As shown in the schematic graph of FIG. 9, in the case of the pulverization using the middle-stage gas introducing means (denoted with ◯), the pulverization was carried out with air introduction of a same flow rate (1.2 m³/min) throughout from the three positions of the feed opening 3, the gas passage 16 closer to the feed opening 3 and the gas passage 16b closer to the discharge opening 4. On the other hand, in the case of the pulverization not using the middle-stage gas introducing means (denoted with ▪), the air introduction of 3.6 m³/min was effected only from one position of the feed opening 3.

In both pulverization methods above, for the air introduction, at having an approximately room temperature of about 10° C. was introduced.

Also, in both of the two pulverization methods above, the cooling of the rotor 10 and the casing 2 using the coolant passage 15, the coolant passage 20 and the coolant circuit 23 was effected under the same conditions.

In both pulverization methods above, the rotational speed at the vicinity of the rugged portion 10G of the rotor 10 was 150 msec, and the power used for the rotation of the rotor 10 was 15 kW at its maximum.

In both pulverization methods above, total of three times of continuous pulverization were effected in the manner described below.

(1) An amount of cyan toner having the maximum particle size of 4 mm (an example of “processing-object powder”) was fed from the feed opening 3 at the feed rate of about 60 kg/h, and the pulverized product discharged from the discharge opening 4 in its entire amount was collected as first pulverized product and the average particle size (first time) was determined and recorded.

(2) The first pulverized product in its entire amount was fed from the feed opening 3 at the feed rate of about 60 kg/h and pulverized product discharged from the discharge opening 4 was collected in its entire amount as second pulverized product and the average particle size (second time) was determined and recorded.

(3) The second pulverized product in its entire amount was fed from the feed opening 3 at the feed rate of about 60 kg/h and pulverized product discharged from the discharge opening 4 was collected in its entire amount as third pulverized product and the average particle size (third time) was determined and recorded.

As shown in FIG. 9, in the case of the pulverization using the middle-stage gas introducing means, the average particle size of the pulverized product obtained after the first time of pulverization was about 6 μm and the size was about 5.2 μm after the second time and the size reached about 4.7 μm after the third time.

On the other hand, in the case of the pulverization not using the middle-stage gas introducing means, the average particle size of the pulverized product obtained after the first time of pulverization was about 7.9 μm and the size was about 5.8 μm after the second time and the size was about 5.3 μm after the third time.

As described above, significant effects of the pulverization using the middle-stage gas introducing means were confirmed, such as the ability of obtaining pulverized product of average particle size of about 6 μm after the first pass, in contrast to the pulverization without using the middle-stage gas introducing means which required two times of pass until the pulverized product having the average particle size of about 6 μm could be obtained.

Incidentally, as shown in the schematic graph of FIG. 9, in the case of the pulverization not using the middle-stage gas introducing means, the temperature of the gas at the discharge opening 4 was 37° C., whereas in the case of the pulverization using the middle-stage gas introducing means, the temperature of the same gas was 23° C. This result also shows the cooling effect by the middle-stage gas introducing means.

The pulverizing apparatus according to the present invention can be used in a manufacturing process for manufacturing toner (fine powdered ink for use in coloring of paper in a copier or a laser printer).

Toner is provided as a product obtained by mixing binding resin, coloring agent, electric charge controlling agent, melting and kneading the resultant mixture together by an extruder, cooling the mixture for its solidification and pulverizing and classifying the resultant solid into material having a desired particle size range. The above is the basic manufacturing process of toner. In many cases, however, the process is added with further processing steps until the material is finished into a product through the fine pulverization and classification. Namely, the fine powder after pulverization or fine powder after classification will be directly spheroidized or subjected to surface reforming and then external addition to be made into a final product. Incidentally, the classification step (coarse powder classification or fine powder classification) may sometimes be added before/after the above additional steps of spheroidization, surface reforming, and external addition, in addition to the addition thereof between the course pulverization and fine pulverization.

Next, the pulverization step and the classification step will be explained. Coarsely pulverized toner is subject to fine pulverization and then classified by the classifier into course powder and fine powder. In this, if the fine powder is to be obtained as the final product, the course powder will be returned to the fine pulverizer for re-pulverization. If the fine powder does not reach a predetermined particle size even with using the fine pulverizer, further pulverization is effected with using a superfine pulverizer capable of even finer pulverization. Then, classification will be effected with using an appropriate classifier for obtaining fine particles having the predetermined particle size range. If product having a predetermined particle size range is to be obtained from the fine powder obtained from the classifier, classification will be effected with using still another classifier and then fine particle powder having particle sizes below the predetermined particle size will be removed and the remaining fine powder (“intermediate powder”) may be obtained as the final product.

Or, in some cases, the toner particles obtained by the pulverization or classification may be subject to still further surface treatment process described below. That is, the toner particles may be spheroidized or subjected to surface reforming with embedding other fine particles in the particle surfaces or addition of e.g. fine particulate silica as an external additive to the surfaces. Normally, the addition of the external additive is effected at the step immediately before the step for finalizing product. In some cases, however, the addition may be effected also before/after the classification or spheroidization. For instance, the classification step (coarse powder classification or fine powder classification) may be introduced after spheroidization or surface reforming. The subsequent steps after the series of pulverization/classification in the toner manufacturing process described above, including the addition or omission of the additional steps, may vary appropriately in accordance with the purpose of the product, the processing conditions, etc.

As described above, the most basic flow for manufacture of toner can be expressed as: (raw material)→(cooling solidification)→(pulverization/classification)→(product). As the devices usable for the more specific steps of (pulverization/classification), i.e. the coarse pulverization, fine pulverization, superfine pulverization, classification, surface treatment, external addition, the following devices can be cited.

The devices usable for the coarse pulverization include a hammer mill, a pin mill, etc. and as examples of commercial names of the specific products, there can be cited PULPELIZER (Hosokawa Micron Corporation), ACM PULPELIZER (Hosokawa Micron Corporation), etc.

The devices usable for the fine pulverization include a jet mill (gas flow type pulverizer), a mechanical pulverizer, etc. and as examples of commercial names of the specific products, there can be cited ACM PULPELIZER (Hosokawa Micron Corporation), INOMIZER (Hosokawa Micron Corporation), TURBO MILL (Turbo Corporation), and the pulverizing apparatus according to the present invention, etc.

The devices usable for the superfine pulverization include a jet mill (gas flow type pulverizer), a mechanical pulverizer, etc. and as examples of commercial names of the specific products, there can be cited TURBO MILL (Turbo Corporation), JET MILL (Hosokawa Micron Corporation), and the pulverizing apparatus according to the present invention, etc.

The devices usable for the classification include an inertia gas flow type classifier, a rotary blade type classifier, and as examples of commercial names of the specific products, there can be cited TURBOPLEX (Hosokawa Micron Corporation), TSP SEPARATOR (Hosokawa Micron Corporation), TTSP SEPARATOR (Hosokawa Micron Corporation), ELBOW JET (Nittetsu Mining Co., Ltd.), etc.

The devices usable for the surface treatment include a spheroidization/surface reforming device, a spheroidization device, a surface reforming device, etc, and as examples of commercial names of the specific products, there can be cited MECHANOFUSION (Hosokawa Micron Corporation), NOBILTA (Hosokawa Micron Corporation), CYCLOMIX (Hosokawa Micron Corporation), FACULTY (Hosokawa Micron Corporation), Henschel Mixer (Nippon Coke & Engineering Co., Ltd.), a heat spheroidization device, etc.

The devices usable for the external addition include an external additive mixer, and as examples of commercial names of the specific products, there can be cited MECHANOFUSION (Hosokawa Micron Corporation), NOBILTA (Hosokawa Micron Corporation), CYCLOMIX (Hosokawa Micron Corporation), FACULTY (Hosokawa Micron Corporation), Henschel Mixer (Nippon Coke & Engineering Co., Ltd.), COMPOSI (Nippon Coke & Engineering Co., Ltd.), etc.

The pulverizing apparatus according to the present invention is usable not only for fine pulverization, superfine pulverization, but also as an apparatus for spheroidization or surface reforming, if provided with changes in the apparatus setting.

### INDUSTRIAL APPLICABILITY

The present invention is applicable as a pulverizing apparatus including a casing having a cylindrical inner face, a rotor driven to rotate about the axis of the casing and having an rugged portion in its outer periphery, a gas flow forming means for forming a gas flow for conveying the powder material from a feed opening provided at an end of the casing along the axis direction to a discharge opening provided at the other axial end of the casing, and a coolant supplying means for causing coolant to flow in a coolant passage formed inside the rotor.

### DESCRIPTION OF REFERENCE MARKS/NUMERALS

1 pulverizing apparatus
2 casing
2a outer cylinder
2b inner cylinder
2G rugged portion
3 feed opening
4 discharge opening
10 rotor
10G rugged portion
10P pulverizing rotor piece
11 cutout portion
14 heat exchanger
15 coolant passage
15R annular passage
16 gas passage (middle-stage gas introducing means, 16a, 16b)
17 gas supplying cases (17a, 17b, 17c, 17d)
18 annular slit (opening)
20 second coolant passage
23 coolant circuit
25 bag filter
26 blower (gas flow forming means)
M motor
p pump (coolant supplying means)
X axis

1. A pulverizing apparatus comprising:
a casing having a cylindrical inner face and a longitudinal axis;
a rotor driven to rotate about the longitudinal axis of the casing and having an rugged portion in its outer periphery;
a gas source providing a gas flow for conveying a powder material from a feed opening provided at an end of the casing along an axial direction to a discharge opening provided at an opposite axial end of the casing; and
a coolant source providing coolant to flow in a coolant passage formed inside the rotor;
wherein the rugged portion is divided along the axial direction by an annular cutout portion extending along a peripheral direction of the rotor.

2. The pulverizing apparatus according to claim 1, wherein at a portion of the casing facing the cutout portion, there is provided an opening for introducing gas into the cutout portion of the rotor.

3. The pulverizing apparatus according to claim 2, wherein a plurality of sets of said annular cutout portions and said openings are provided along the axial direction.

4. The pulverizing apparatus according to claim 2, wherein the cutout portion has a width that exceeds an opening width of said opening.

5. The pulverizing apparatus according to claim 1, wherein said coolant passage includes a peripheral annular passage adjacent said cutout portion along the axial direction; and said cutout portion has a radial depth substantially equal to an inner radial end of the annular passage.

6. The pulverizing apparatus according to claim 1, wherein a second coolant passage is formed inside the casing.
